(19) United States
(12) Patent Application Publication
(10) Pub. No.: US 2012/0015115 A1
(43) Pub. Date: Jan. 19, 2012

(54) DISPLAY PANEL

(75) Inventors: Yang-Chu Lin, Hsinchu City (TW); Li-Wei Kung, Taipei County (TW); Liang-Ying Huang, Hsinchu City (TW); Hsin-An Cheng, Hsinchu County (TW); Norio Sugiura, Hsinchu (TW); Wei-Lung Liau, Hsinchu City (TW)

(73) Assignee: AU OPTRONICS CORPORATION, Hsinchu (TW)

(21) Appl. No.: 12/944,724

(22) Filed: Nov. 12, 2010

(30) Foreign Application Priority Data
Jul. 19, 2010 (TW) 99123636

(51) Int. Cl. C09K 19/00

(52) U.S. Cl. 428/1.2

(57) ABSTRACT

A display panel includes a first substrate, a second substrate, a liquid crystal material between the first and second substrates, and an alignment layer on at least one of the first and second substrates. The liquid crystal material includes 10-90 wt % of a non-polar liquid crystal compound and 10-90 wt % of a polar liquid crystal compound, wherein a total amount of the non-polar and the polar liquid crystal compounds is 100 wt %. The non-polar liquid crystal compound has a dielectric anisotropy (Δε) of −1≦Δε≦1, and the polar liquid crystal compound has a dielectric anisotropy (Δε) of Δε≧1. The alignment layer has at least one of a polyamic acid and a cyclodehydration of the polyamic acid, wherein the polyamic acid is obtained by reacting a diamine compound with a tetracarboxylic acid dianhyhydirde compound.

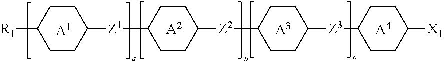

### CROSS-REFERENCE TO RELATED APPLICATION

This application claims the priority benefit of Taiwan application serial no. 99123636, filed on Jul. 19, 2010. The entirety of the above-mentioned patent application is hereby incorporated by reference herein and made a part of this specification.

### BACKGROUND OF THE INVENTION

1. Field of the Invention

The invention is related to a display panel, and in particular to a liquid crystal display (LCD) panel.

2. Description of Related Art

In recent years, in order to make LCD panels consume less power, it is common practice in the industry to configure driving devices at lower frame frequencies and grayscale display function. However, charged ions in an LCD panel have enough movement time to form an internal electric field, which alters an arrangement of liquid crystal molecules, thereby causing problems in display quality of the LCD panel. These problems include: abnormal voltage holding ratios (VHR), threshold voltages and image retention effects.

Generally, in LCD panels driven by low voltages (lower than 3 V), liquid crystal materials thereof are often predominantly made of liquid crystal compounds which have a high dielectric anisotropy or high polarity, so as to comply with requirements of low voltages and faster response time. However, a combination of such types of liquid crystal materials and conventional alignment layers often reduces the reliability of display panels.

### SUMMARY OF THE INVENTION

The disclosure provides a display panel, wherein a combination of a liquid crystal material and an alignment layer material is capable of resolving problems of low reliability in conventional LCD panels driven by low voltages.

The disclosure provides a display panel which includes a first substrate, a second substrate, a liquid crystal material disposed between the first substrate and the second substrate, and an alignment layer disposed on at least one of the first substrate and the second substrate. In particular, the liquid crystal material includes 10-90 wt % of a non-polar liquid crystal compound and 10-90 wt % of a polar liquid crystal compound. The non-polar liquid crystal compound has a dielectric anisotropy (Δε) of −1≦Δε≦1, the polar liquid crystal compound has a dielectric anisotropy (Δε) of Δε≧1, and a total amount of the non-polar and the polar liquid crystal compounds is 100 wt %. Each of the non-polar and polar liquid crystal compounds is selected from a compound represented by Formula (1).

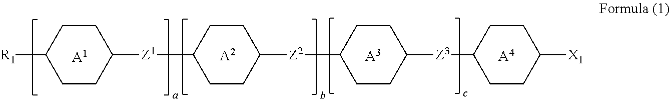

R₁ is a substituted or non-substituted alkyl group with 1-15 carbons or alkenyl group with 2-15 carbons.

Each of A¹, A², and A³ represents:

(i) a substituted or non-substituted trans-1,4-cyclohexenyl group, trans-1,4-cyclohexyl group, or 1,4-phenyl group; or

(ii) one of a piperidine-1,4-diyl group, a 1,4-bicyclo[2.2.2]octylene group, a naphthaline-2,6-diyl group, a decahydronaphthaline-2,6-diyl group, a 1,2,3,4-tetrahydronaphthaline-2,6-diyl group, a phenanthrene-2,7-diyl, and a fluorene-2,7-diyl group.

A⁴ represents one of the following groups:

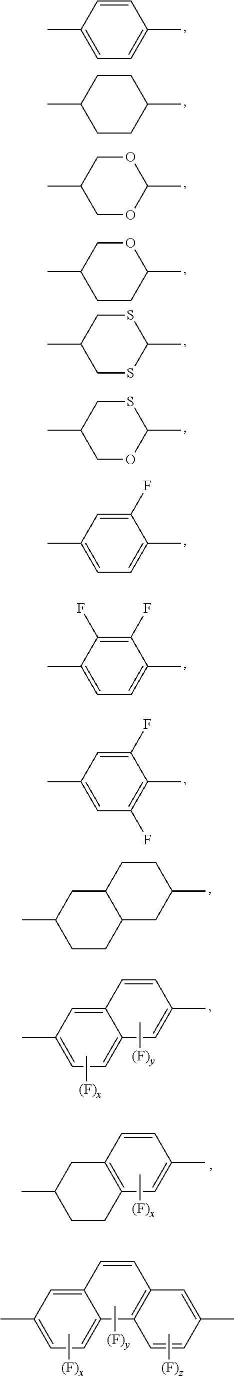

Each of x, y, and z represents 0, 1, or 2;

Each of Z¹, Z², and Z³ represents one of —CO—O—, —O—CO—, —CF₂O—, OCF₂—, —CH₂O—, —OCH₂—, —(CH₂)₃O—, —O(CH₂)₃—, —CH₂CH₂—, —(CH₂)₄—, —C₂F₄—, —CH₂CF₂—, —CF₂CH₂—, —CF═CF—, —CH═CH—, —C≡—C, —CH═CHCH₂CH₂—, —CH₂CH═CHCH₂—, —CH₂CH₂CH═CH—, —CH═CHCH═CH—, —CH═CHCH₂O—, —OCH₂CH═CH—, —(CH₂)₂COO—, —OCO(CH₂)₂—, —CH═CHCOO—, —OCOCH═CH—, —CH═CHCC—, —CC—CH═CH—, and a single bond, wherein the term “single bond” indicates that rings are directly bonded to each other, excluding carbons in between.

X₁ is one of F, Cl, CN, SF₅, NCS, and a halogenated or non-substituted alkyl group with 1-8 carbons or alkenyl group with 2-8 carbons.

Each of a, b, and c is 0, 1, or 2, and a+b+c≦3.

In addition, the alignment layer includes at least one of a polyamic acid and a cyclodehydration of the polyamic acid, and the polyamic acid is obtained by reacting a diamine compound with a tetracarboxylic acid dianhyhydirde compound, wherein the diamine compound is represented by Formula (2):

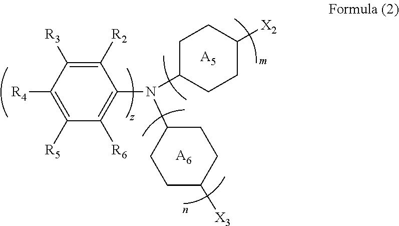

Each of X₂`X₃ is —NH₂, an alkyl group with 1-12 carbons, or an alkenyl group with 2-12 carbons.

Each of A₅ and A₆ represents one of following groups:

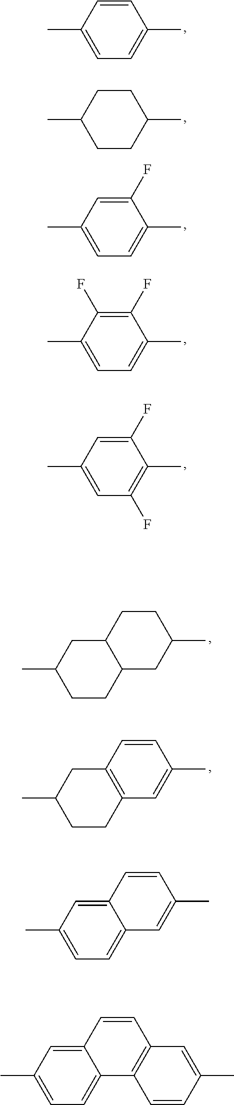

Each of R₂-R₆ is a hydrogen or an NH₂ group, and at least one of R₂-R₆ is an NH₂ group. Each of m, n, and z represents 0, 1, or 2. In light of the above, since the disclosure adopts combinations of special liquid crystal materials and alignment layer materials, it is capable of resolving problems of low reliability in LCD panels driven by low voltages

In order to make the aforementioned and other objects, features and advantages of the disclosure comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of a display panel according to an embodiment of the invention.

FIG. 2 is a schematic view of a residual DC voltageresidual DC voltage (Vrdc) test result according to an embodiment of the invention.

FIG. 3 is a schematic view of an image retention test result according to an embodiment of the invention.

### DESCRIPTION OF EMBODIMENTS

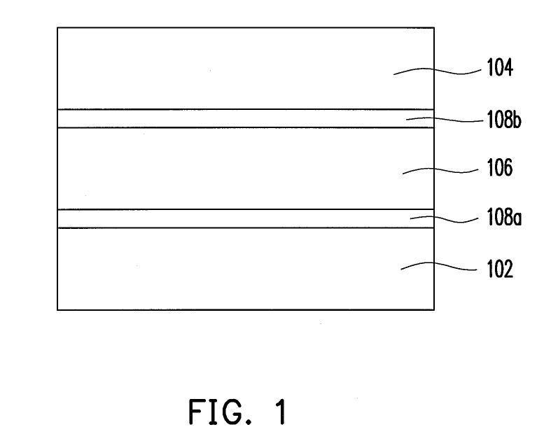

FIG. 1 is a schematic cross-sectional view of a display panel according to an embodiment of the invention. Referring to FIG. 1, the display panel according to the present embodiment includes a first substrate 102, a second substrate 104, a liquid crystal material 106 disposed between the first substrate 102 and the second substrate, and alignment layers 108a and 108b disposed on the first substrate 102 and the second substrate 104. The above first substrate 102 is, for example, a pixel array substrate which includes a plurality of scan lines, a plurality of data lines, a plurality of active devices, and a plurality of pixel electrodes disposed on a blank substrate. The second substrate 104 is, for example, a color filter substrate which includes a color filter array, a shading pattern layer, and an electrode layer disposed on a blank substrate. The second substrate 104 may also be an opposite substrate which includes a black substrate and an electrode layer, or simply a blank substrate.

According to the present embodiment, the alignment layers 108a and 108b are respectively disposed on the first substrate 102 and the second substrate 104. However, the disclosure is not limited to this configuration. According to another embodiment, only the alignment layer 108a is disposed on the first substrate 102, or only the alignment 108b is disposed on the second substrate 104.

The following describes in detail compositions of the liquid crystal material 106 and the alignment layers 108a and 108b in the display panel. In order to enhance reliability of LCD panels driven by low voltages (lower than 3 V), the disclosure provides multiple embodiments describing combinations of special liquid crystal materials and alignment layers.

### Liquid Crystal Materials

The liquid crystal material of the disclosure includes 10-90 wt % of a non-polar liquid crystal compound and 10-90 wt % of a polar liquid crystal compound, wherein a total amount of the non-polar and the polar liquid crystal compounds is 100 wt %. Preferably, the liquid crystal material 106 includes 10-50 wt % of a non-polar crystal compound and 50-90 wt % of a polar liquid crystal compound. More preferably, the liquid crystal material 106 includes 15-35 wt % of a non-polar crystal compound and 65-85 wt % of a polar liquid crystal compound.

The non-polar liquid crystal material has a dielectric anisotropy (Δε) of −1≦Δε≦1. In addition, the polar liquid crystal material has a dielectric anisotropy (Δε) of Δε≧1. Preferably, the polar liquid crystal material has a dielectric anisotropy (Δε) of 1≦Δε≦25.

Each of the above non-polar and polar liquid crystal compounds is selected from a compound represented by Formula (1).

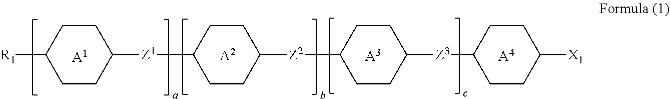

R₁ is a substituted or non-substituted alkyl group with 1-15 carbons or alkenyl group with 2-15 carbons. For example, one or more hydrogens in R₁ may be substituted by a halogen, CN, or CF₃, or one or more of the CH₂ groups in R₁ may be independently substituted by —O—, —S—, —C≡C—, —CO—, —CO—O—, —O—CO—, or O—CO—O—, and none of the oxygens is bonded to each other.

A¹, A², and A³ each independently represents:
(i) a substituted or non-substituted trans-1,4-cyclohexenyl group, a trans-1,4-cyclohexyl group, or a 1,4-phenyl group; for example, one or more non-contiguous CH₂ groups in the trans-1,4-cyclohexenyl group or the trans-1,4-cyclohexyl group may be substituted by —O— or —S—, and one or more CH groups in the 1,4-phenyl group may be substituted by N; or

(ii) one of a piperidine-1,4-diyl group, a 1,4-bicyclo[2.2.2]octylene group, a naphthaline-2,6-diyl group, a decahydronaphthaline-2,6-diyl group, a 1,2,3,4-tetrahydronaphthaline-2,6-diyl group, a phenanthrene-2,7-diyl, and a fluorene-2,7-diyl group.

The groups in (i) or (ii) may also be single-substituted or multi-substituted by halogens.

A⁴ represents one of the following groups:

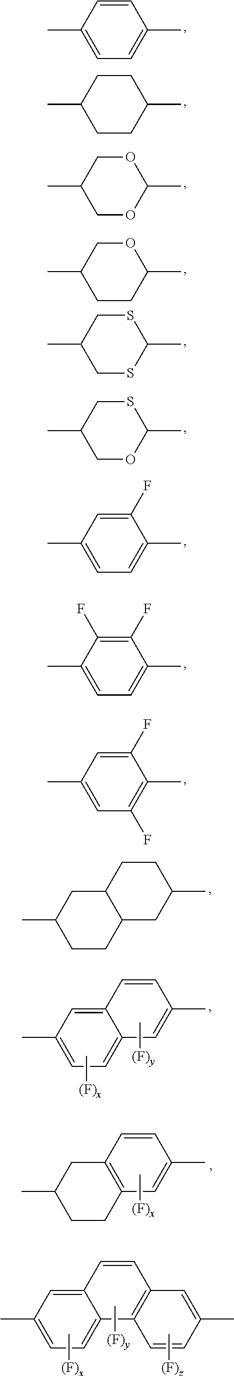

Each of x, y, and z represents one of 0, 1, and 2.

Each of Z¹, Z², and Z³ may be one of —CO—O—, —O—CO—, —CF₂O—, OCF₂—, —CH₂O—, —OCH₂—, —(CH₂)₃O—, —O(CH₂)₃—, —CH₂CH₂—, —(CH₂)₄—, —C₂F₄—, —CH₂CF₂—, —CF₂CH₂—, —CF═CF—, —CH═CH—, —C≡—C, —CH═CHCH₂CH₂—, —CH₂CH═CHCH₂—, —CH₂CH₂CH═CH—, —CH═CHCH═CH—, —CH═CHCH₂O—, —OCH₂CH═CH—, —(CH₂)₂COO—, —OCO(CH₂)₂—, —CH═CHCOO—, —OCOCH═CH—, —CH═CHC≡C—, —C≡C—CH═CH—, and a single bond, wherein the term “single bond” indicates that rings are directly bonded to each other, excluding carbons in between.

X₁ is one of F, Cl, CN, SF₅, NCS, and a halogenated or non-substituted alkyl group with 1-8 carbons or alkenyl group with 2-8 carbons. For example, X₁ is one of F, Cl, CN, SF₅, NCS, and a halogenated or non-substituted alkyl group with 1-8 carbons or alkenyl group with 2-8 carbons, and one or more CH₂ groups in X₁ may be independently substituted by —O—, —S—, —C≡C—, —CO—, —CO—O—, —O—CO—, or O—CO—O—, and none of the oxygens is bonded to each other.

Each of a, b, and c is one of 0, 1, and 2, and a+b+c≦3.

According to the above description and the present embodiment, the non-polar liquid crystal compound in the liquid crystal material includes at least one of the following:

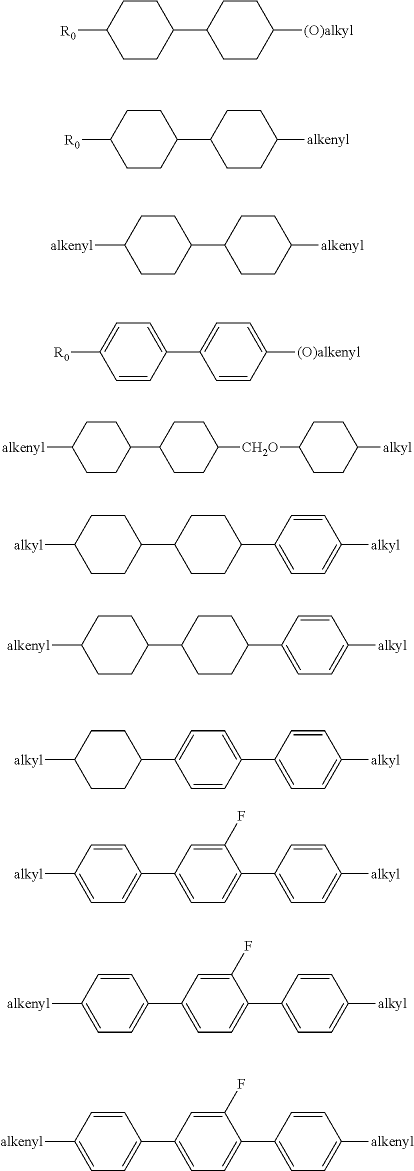

R⁰ represents a 1-8 carbon n-alkyl group, n-alkoxy group, oxaalkyl group, fluoroalkyl group, alkenyloxy group, or an alkenyl group. The alkyl group is a branched or unbranched alkyl group with 1-8 carbons, an (O)alkyl group represents a branched or unbranched alkenyl group or an oxaalkyl group with 1-8 carbons, and the alkenyl group represents a branched or unbranched alkenyl group with 2-8 carbons.

In other words, the non-polar liquid crystal compound in the liquid crystal material may be one of the above non-polar liquid crystal compounds or a combination of some of the above non-polar liquid crystal compounds.

In addition, according to the present embodiment, the polar liquid crystal compound in the liquid crystal material includes at least one of the following:

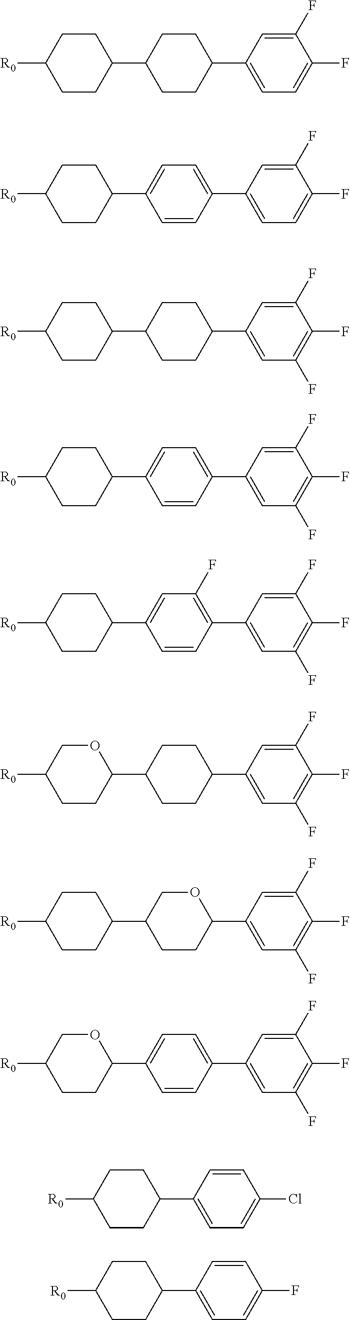

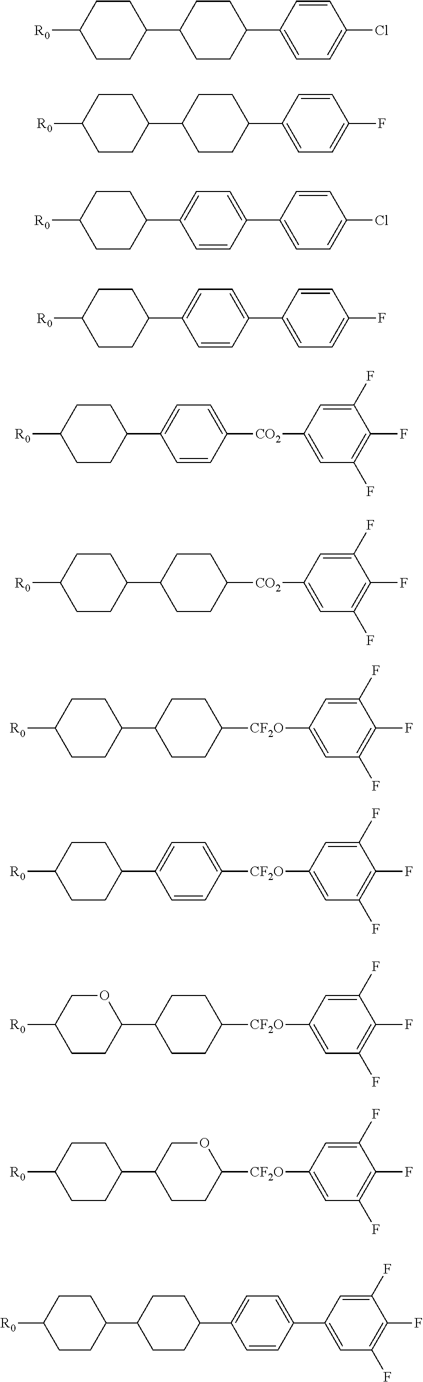

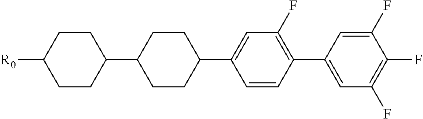

R⁰ represents a 2-12 carbon n-alkyl group, n-alkoxy, oxaalkyl group, fluoroalkyl group, alkenyloxy group, or alkenyl group.

In other words, the polar liquid crystal compound in the liquid crystal material may be one of the above polar liquid crystal compounds or a combination of some of the above polar liquid crystal compounds.

According to a more preferable embodiment, a material of the liquid crystal material mainly includes:

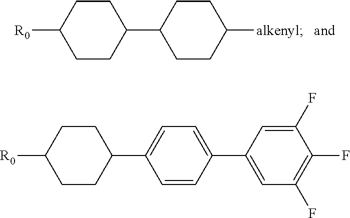

In addition, according to another embodiment, the polar liquid crystal compound in the liquid crystal material includes a first polar liquid crystal compound and a second polar liquid crystal compound. The first polar liquid crystal compound has a dielectric anisotropy (Δε) of 1≦Δε≦25, so that it is termed a moderately polar polar liquid crystal compound. The second polar liquid crystal compound has a dielectric anisotropy (Δε) of 25≦Δε, so that it is termed a highly polar liquid crystal compound. A ratio of the first polar liquid crystal compound to the second polar liquid crystal compound may be 1-10:1.

According to the present embodiment, each of the first and second polar liquid crystal compounds includes at least one of the following:

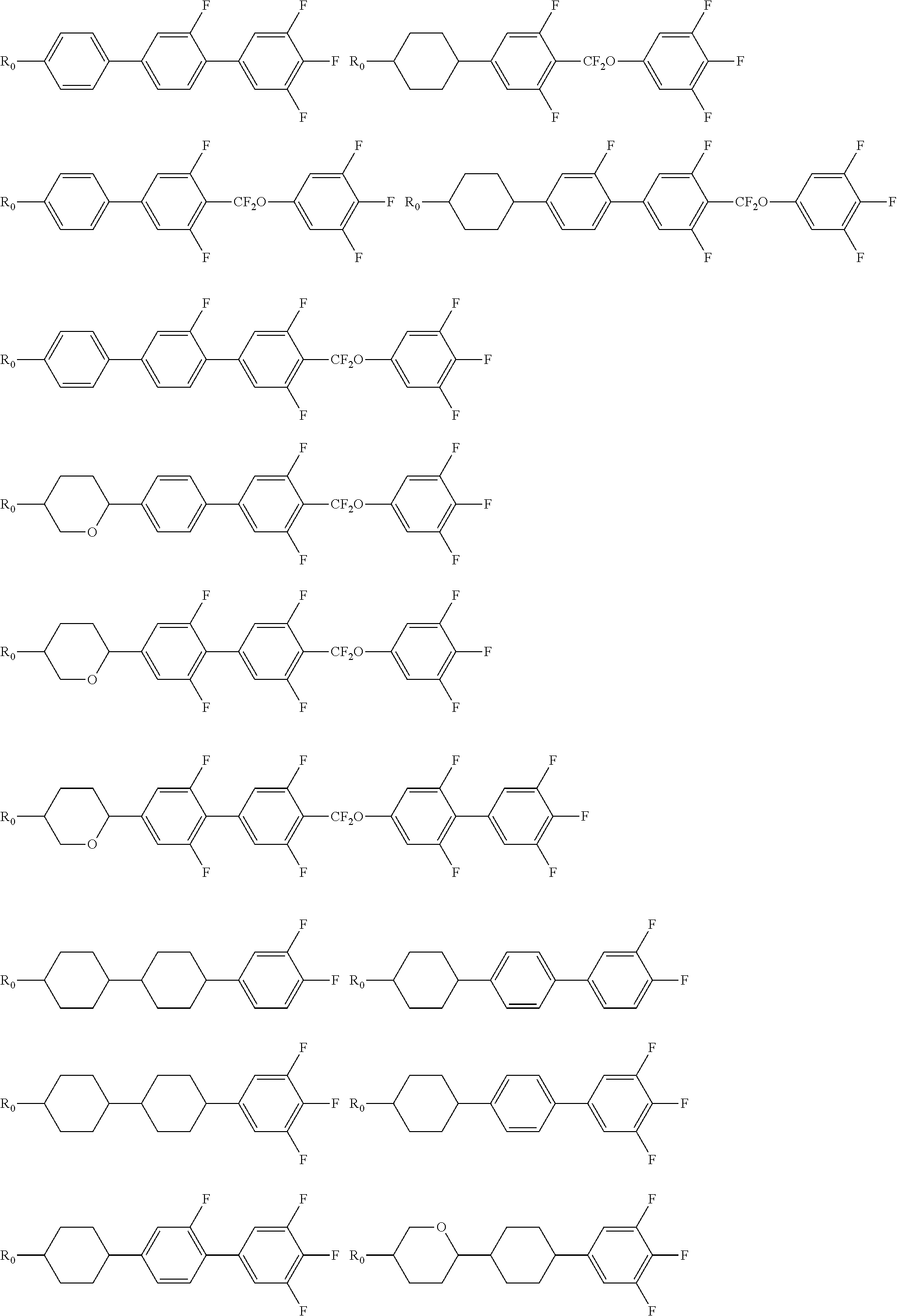

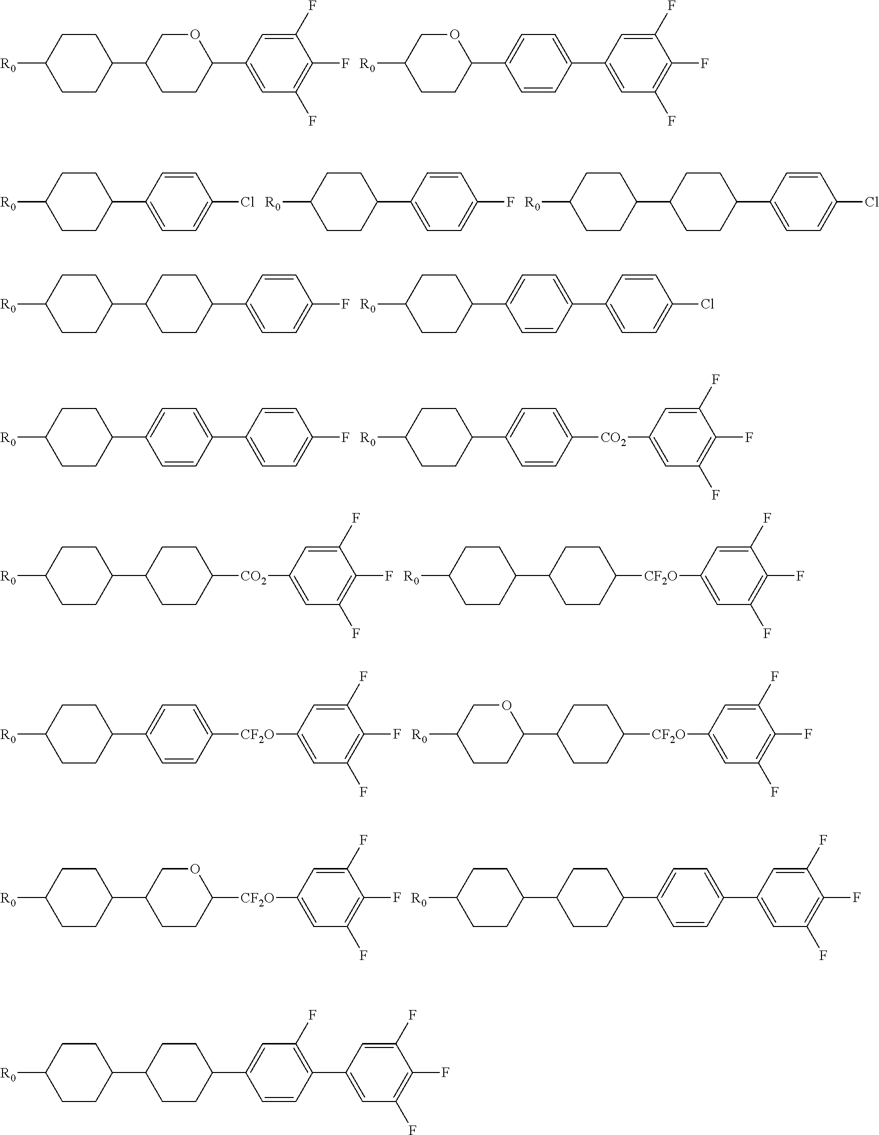

R⁰ represents a 2-12 carbon n-alkyl group, n-alkoxy, oxaalkyl group, fluoroalkyl group, alkenyloxy group, or alkenyl group.

In other words, the first polar liquid crystal compound in the liquid crystal material may be one of the above polar liquid crystal compounds or a combination of some of the above polar liquid crystal compounds. According to a more preferable embodiment, the first polar liquid crystal compound in the liquid crystal material mainly includes:

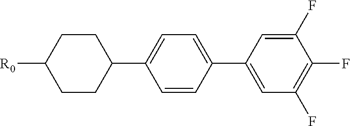

Similarly, the second polar liquid crystal compound in the liquid crystal material may be one of the above polar liquid crystal compounds or a combination of some of the above polar liquid crystal compounds. According to a more preferable embodiment, the second polar liquid crystal compound in the liquid crystal material mainly includes:

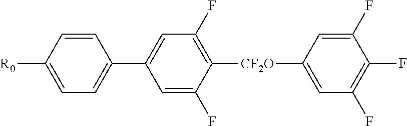

### Alignment Layers

In the disclosure, the alignment layers include at least one of a polyamic acid and a cyclodehydration of the polyamic acid. In particular, the polyamic acid is obtained by reacting a diamine compound with a tetracarboxylic acid dianhyhydirde compound, wherein the diamine compound is shown in Formula (2).

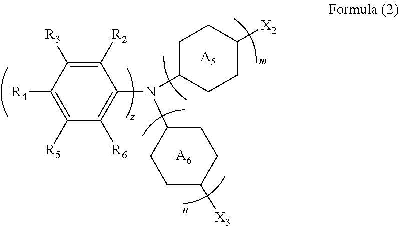

X₂`X₃ each independently represents —NH₂, an alkyl group with 1-12 carbons, or an alkenyl group with 2-12 carbons.

Each of A₅ and A₆ represents one of the following:

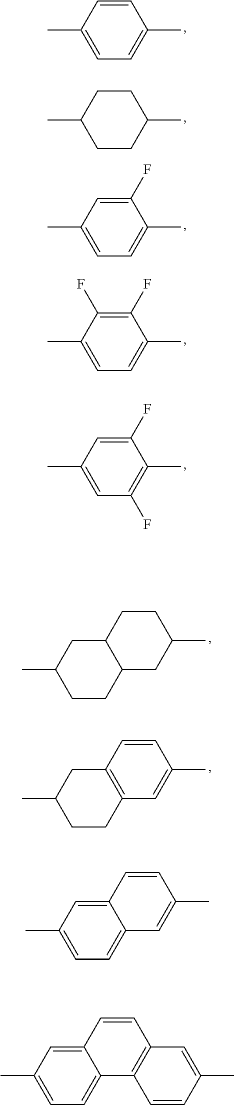

R₂-R₆ each independently represents a hydrogen or an NH₂ group, and at least one of R₂-R₆ is an NH₂ group. Preferably, two of R₂-R₆ are NH₂ groups.

Moreover, m, n, and z each represents one of 0, 1, and 2.

According to the present embodiment, the above diamine compound includes at least one of the following:

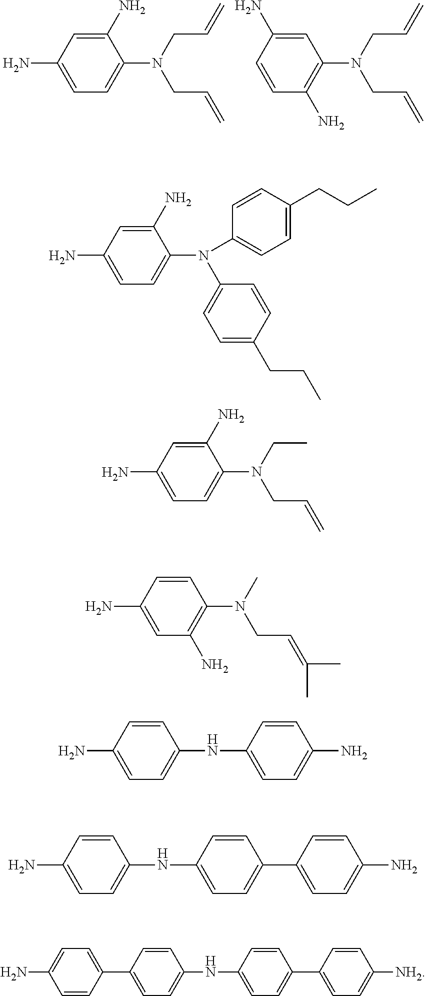

According to the present embodiment, a method for synthesizing the above alignment layer material is described in the following. In a reaction of synthesizing polyimide, one mole of the diamine compound is mixed with one mole of the tetracarboxylic acid dianhyhydirde compound in N-Methyl-2-pyrrolidone (NMP). The mixture is reacted at room temperature for 24 hours, and the polyamic acid solution is obtained. Suitable amounts of NMP, butyl cellosolve (BCS), and γ-butyrolactone (γ-BL) solvent are then added, so as to obtain the polyamic acid solution having about 5-6% solid content.

Next, the polyamic acid solution (which is an alignment material solution) is coated on the first substrate and/or the second substrate of the display panel. Afterwards, after drying on a 80° C. heat plate for five minutes, an imidization reaction is performed in a 230° C. hot air circulatory oven for 30 minutes, and the alignment layers according to the present embodiment are obtained.

### Experimental Embodiment

The following describes testing of parameters such as residual DC voltage (Vrdc), voltage holding ratio (VHR), and image retention effects in combinations of three types of liquid crystal compounds (LC-1, LC-2, and LC-3) with three types of alignment layer materials (PI-1, PI-2, and PI-3).

The compositions and ratios of the three types of liquid crystal compounds (LC-1, LC-2, and LC-3) are described in Tables 1, 2, and 3.

TABLE 1
(the liquid crystal composition LC-1)

| LC Composition | Ratio (wt %) |
|---|---|
| 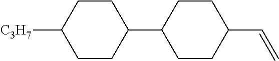 | 20 |
| 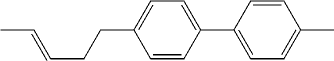 | |
| 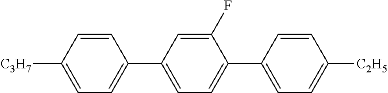 | |
| 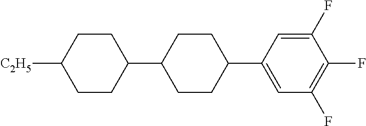 | 80 |
| 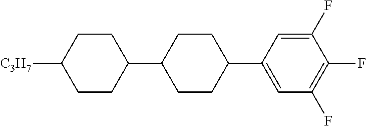 | |
| 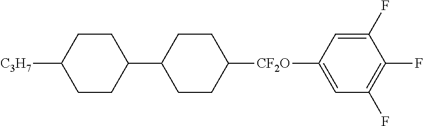 | |
| 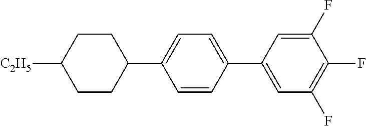 | |
| 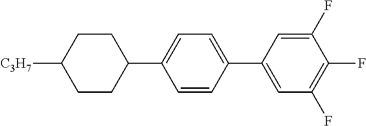 | |
| 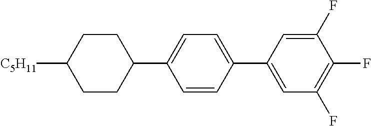 | |
| 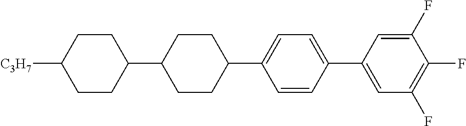 | |
| 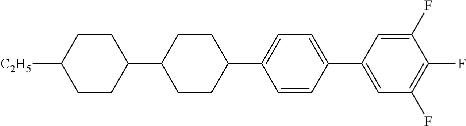 | |
| 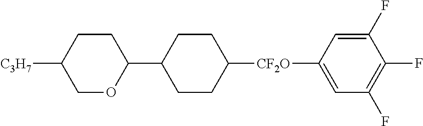 | |

TABLE 2
(the liquid crystal composition LC-2)

| LC Composition | Ratio (wt %) |
|---|---|
| 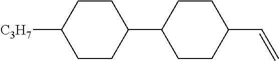 | 20 |
| 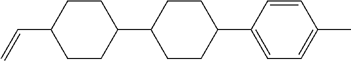 | |
| 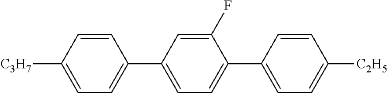 | |
| 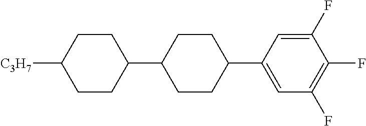 | 65 |
| 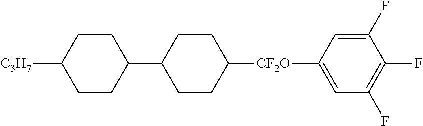 | |
| 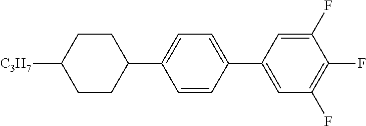 | |
| 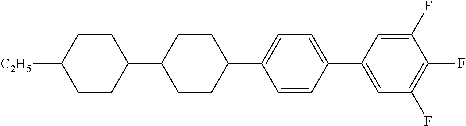 | |
| 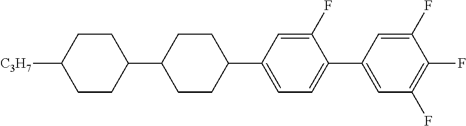 | |
| 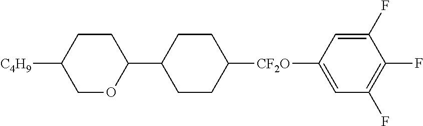 | |
| 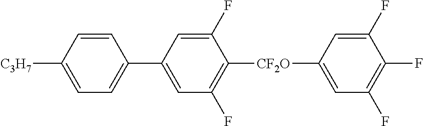 | 10 |
| 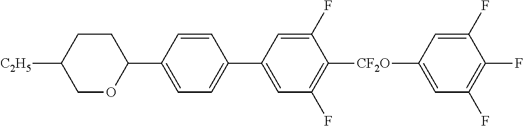 | |
| 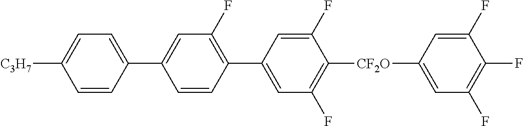 | |

TABLE 3
(the liquid crystal composition LC-3)

| LC Composition | Ratio (wt %) |
|---|---|
| 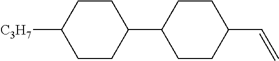 | 35 |
| 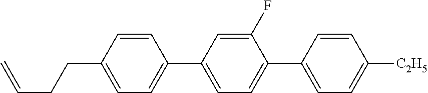 | |
| 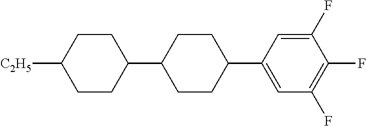 | 50 |
| 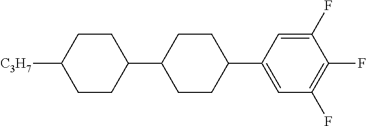 | |
| 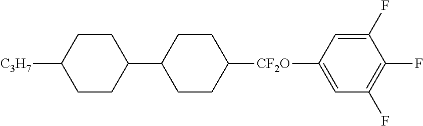 | |
| 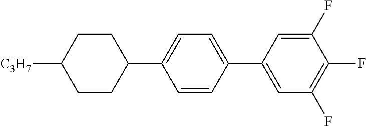 | |
| 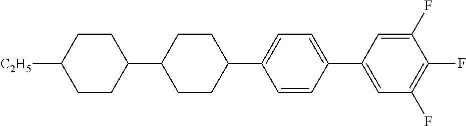 | |
| 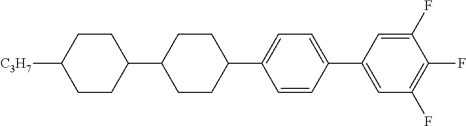 | |
| 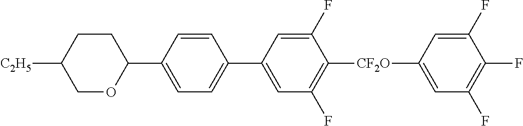 | 15 |
| 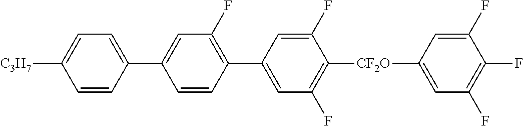 | |
| 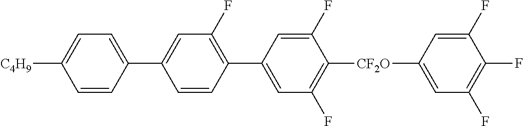 | |

The three types of liquid crystal compositions (LC-1, LC-2, and LC-3) have dielectric anisotropies (Δε) about 8. In addition, the composition ratios of the non-polar liquid crystal compounds, moderately polar liquid crystal compounds, and the highly polar liquid crystal compounds in the three types of liquid crystal compositions LC-1, LC-2, and LC-3 are shown in Table 4.

TABLE 4

| | Non-polar | Moderately polar | Highly polar |
|---|---|---|---|
| | (−1 ≦ Δε ≦ 1) | (1 ≦ Δε ≦ 25) | (25 ≦ Δε) |
| LC-1 | 20 wt % | 80 wt % | 0 wt % |
| LC-2 | 25 wt % | 60 wt % | 10 wt % |
| LC-3 | 35 wt % | 50 wt % | 15 wt % |

In other words, the liquid crystal composition LC-1 only includes a combination of a non-polar liquid crystal compound and a moderately polar liquid crystal compound. The liquid crystal composition LC-2 includes 10 wt % of a highly polar liquid crystal compound. The liquid crystal composition (LC-3) includes 15 wt % of a highly polar liquid crystal compound.

In addition, the diamine compounds and the tetracarboxylic acid dianhyhydirde compounds used to form the three types of alignment layer materials PI-1, PI-2, and PI-3 are shown in Table 5.

TABLE 5

| | Tetracarboxylic acid | Diamine |
|---|---|---|
| | dianhyhydirde compound | compound |
| PI-1 | CBDA | p-PDA |
| PI-2 | CBDA | 2,4-DPA |
| PI-3 | CBDA | 2,4-DAA |

The chemical formula of the tetracarboxylic acid dianhyhydirde compound CBDA is:

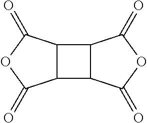

The chemical formula of the diamine compound p-PDA is:

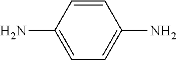

The chemical formula of the diamine compound 2,4-DPA is:

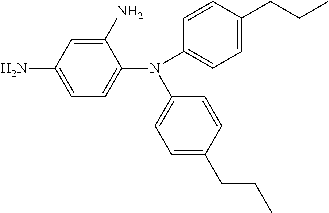

The chemical formula of the diamine compound 2,4-DAA is:

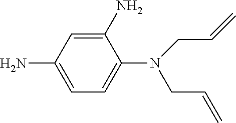

### Vrdc Test Results

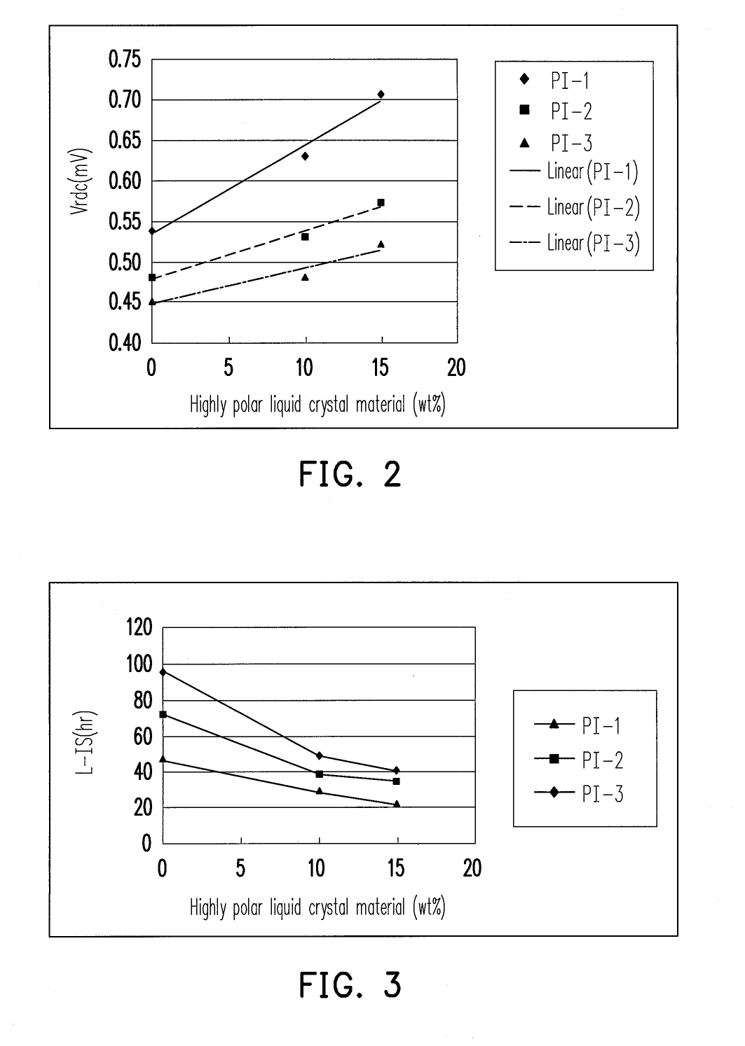

The three types of liquid crystal compositions LC-1, LC-2, and LC-3 are injected into LCD panels which have the different alignment layers PI-1, PI-2, and PI-3. Vrdc tests are then performed, wherein the test results are shown in Table 5 and FIG. 2.

TABLE 5

| | Vrdc (mV) | | |
|---|---|---|---|
| | PI-1 | PI-2 | PI-3 |
| LC-1 | 0.54 | 0.48 | 0.45 |
| LC-2 | 0.63 | 0.53 | 0.48 |
| LC-3 | 0.71 | 0.57 | 0.52 |

In FIG. 2, the X axis represents the ratio of highly polar liquid crystal compounds in the liquid crystal compositions, and the Y axis represents the Vrdc value. According to FIG. 2, the Vrdc value increases with the ratio of the highly polar liquid crystal compounds. In addition, the different alignment layers PI-1, PI-2, and PI-3 have different Vrdc values. According to FIG. 2, the lowest Vrdc value is obtained by the combination of the liquid crystal composition LC-1 and the alignment layer PI-3.

### VHR Test Results

The three types of liquid crystal compositions LC-1, LC-2, and LC-3 are injected into the LCD panel which has the alignment layer PI-3. VHR tests are then performed. The test results are shown in Table 6.

TABLE 6

| | |
|---|---|
| Alignment layer aging | |
| condition | VHR(5 V, 60 Hz) |

| | | | |
|---|---|---|---|
| LC-1 | 0 | hr | 99.63 |
| | 120° C./5 | hr | 99.55 |
| LC-2 | 0 | hr | 99.65 |
| | 120° C./5 | hr | 99.60 |
| LC-3 | 0 | hr | 99.63 |
| | 120° C./5 | hr | 99.60 |

According to Table 6, the display panel in which the liquid crystal composition LC-1 having the non-polar liquid crystal compound and the moderately polar liquid crystal compound is used with the alignment layer PI-3 has a lower VHR value. After the display panel which utilizes the combination of the liquid crystal composition LC-1 and the alignment layer PI-3 is aged for 5 hours at 120° C., a lower VHR value is also obtained.

### Image Retention Test Results

The three types of liquid crystal compositions (C-1, LC-2, and LC-3 are injected into LCD panels which have the different alignment layers PI-1, PI-2, and PI-3. Checkerboard image retention tests are then performed. In the image retention tests, the display panels are switched to grayscale, so as to observe whether line-type image sticking (L-IS) occurs. The test results are shown in FIG. 3, wherein the X axis represents the ratio of highly polar liquid crystal compounds in the liquid crystal compositions, and the Y axis represents the duration of L-IS.

According to FIG. 3, the LCD panel which utilizes the combination of the liquid crystal compositions LC-1 and the alignment layer PI-3 has a better image retention characteristic.

According to the image retention and Vrdc test results, the LCD panel which utilizes the combination of the liquid crystal composition LC-1 and the alignment layer PI-3 has a better image retention characteristic and a lower Vrdc value.

It will be apparent to those skilled in the art that various modifications and variations can be made to the disclosure without departing from the scope or spirit of the disclosure. In view of the foregoing, it is intended that the disclosure cover modifications and variations of this disclosure provided they fall within the scope of the following claims and their equivalents.

1. A display panel, comprising a first substrate, a second substrate, a liquid crystal material disposed between the first substrate and the second substrate, and an alignment layer disposed on at least one of the first substrate and the second substrate, wherein the liquid crystal material comprising:
10-90 wt % of a non-polar liquid crystal compound, having a dielectric anisotropy (Δε) of −1≦Δε≦1; and
10-90 wt % of a polar liquid crystal compound, having a dielectric anisotropy (Δε) of Δε≧1, wherein a total amount of the non-polar liquid crystal material and the polar liquid crystal compound is 100 wt %, wherein the polar liquid crystal compound comprises:
a first polar liquid crystal compound, having a dielectric anisotropy (Δε) of −1≦Δε≦25; and
a second polar liquid crystal compound, having a dielectric anisotropy (Δε) of Δε≧25, wherein an amount of the second polar liquid crystal compound is 0-15 wt %,
where each of the non-polar liquid crystal compound, the first polar liquid crystal compound and the second polar liquid crystal compound is selected from a compound represented by Formula (1): 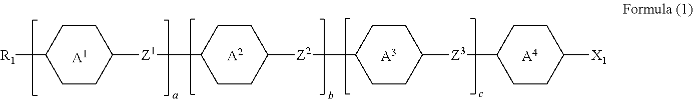
wherein,
R₁ is a substituted or non-substituted alkyl group with 1-15 carbons or an alkenyl group with 2-15 carbons;
A¹, A2, and A3 each independently represents:
(i) a substituted or non-substituted trans-1,4-cyclohexenyl group, trans-1,4-cyclohexyl group, or 1,4-phenyl group; or
(ii) one of a piperidine-1,4-diyl group, a 1,4-bicyclo[2.2.2]octylene group, a naphthaline-2,6-diyl group, a decahydronaphthaline-2,6-diyl group, a 1,2,3,4-tetrahydronaphthaline-2,6-diyl group, a phenanthrene-2,7-diyl, and a fluorene-2,7-diyl group;
A⁴ represents one of following groups: 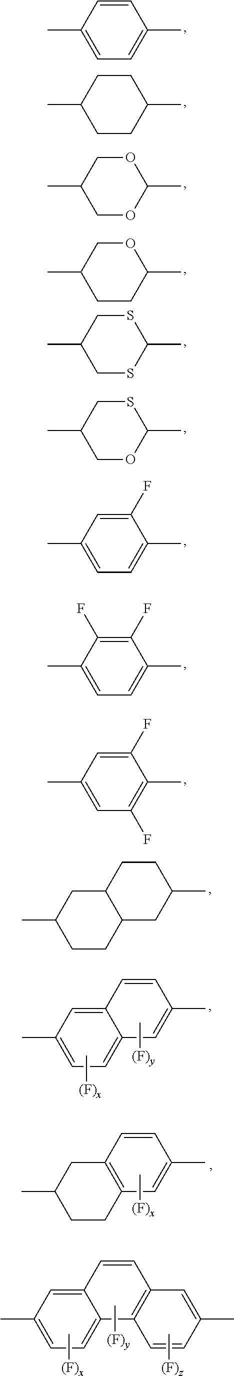
each of x, y, and z represents 0, 1, or 2;
Z¹, Z², and Z³ each independently represents —CO—O—, —O—CO—, —CF₂O—, OCF₂—, —CH₂O—, —OCH₂—, —(CH₂)₃O—, —O(CH₂)₃—, —CH₂CH₂—, —(CH₂)₄—, —C₂F₄—, —CH₂CF₂—, —CF₂CH₂—, —CF═CF—, —CH═CH—, —C≡—C, —CH═CHCH₂CH₂—, —CH₂CH═CHCH₂—, —CH₂CH₂CH═CH—, —CH═CHCH═CH—, —CH═CHCH₂O—, —OCH₂CH═CH—, —(CH₂)₂COO—, —OCO(CH₂)₂—, —CH═CHCOO—, —OCOCH═CH—, —CH═CHC≡C—, —C≡C—CH═CH—, or a single bond;
X₁ is F, Cl, CN, SF₅, NCS, or a halogenated or non-substituted alkyl group with 1-8 carbons or alkenyl group with 2-8 carbons;
each of a, b, and c is 0, 1, or 2, and a+b+c≦3;
the alignment layer comprises at least one of a polyamic acid and a cyclodehydration of the polyamic acid, and the polyamic acid is obtained by reacting a diamine compound with a tetracarboxylic acid dianhyhydirde compound, wherein the diamine compound is represented by Formula (2): 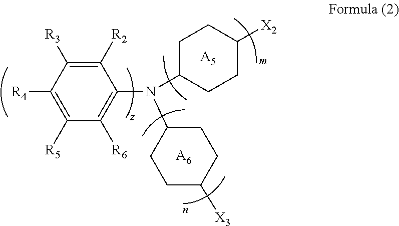
wherein X₂ and X₃ each independently represents —NH₂, an alkyl group with 1-12 carbons, or an alkenyl group with 2-12 carbons;
each of A₅ and A₆ represents one of following groups: 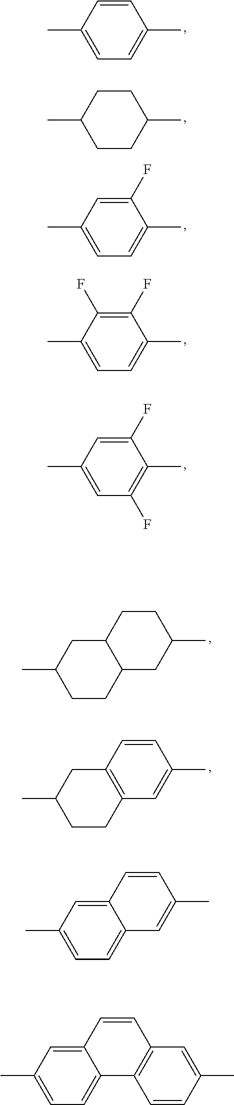
R₂-R₆ each independently represents a hydrogen or an NH₂ group, and at least one of R₂-R₆ is an NH₂ group, and each of m, n, and z represents 0, 1, or 2.

2. (canceled)

3. The display panel as claimed in claim 1, wherein two of R₂-R₆ are NH₂ groups.

4. The display panel as claimed in claim 1, wherein one or more hydrogen atoms in R₁ is substituted by a halogen, CN, or CF₃.

5. The display panel as claimed in claim 1, wherein one or more CH₂ groups in R₁ is independently substituted by —O—, —S—, —C≡C—, —CO—, —CO—O—, —O—CO, or —O—CO—O—, and none of the oxygens is bonded to each other.

6. The display panel as claimed in claim 1, wherein one or more non-contiguous CH₂ groups in the trans-1,4-cyclohexenyl group or the trans-1,4-cyclohexyl group is substituted by —O— or —S—.

7. The display panel as claimed in claim 1, wherein one or two CH groups in the 1,4-phenyl group is substituted by N.

8. The display panel as claimed in claim 1, wherein the groups in (i) and (ii) are monosubstituted or polysubstituted by halogen atoms.

9. The display panel as claimed in claim 1, wherein one or more CH₂ groups in X₁ is independently substituted by —O—, —S—, —C≡C—, —CO—, —CO—O—, —O—CO, or —O—CO—O—, and none of the oxygens is bonded to each other.

10. The display panel as claimed in claim 9, wherein the non-polar liquid crystal compound comprises at least one of following compounds: 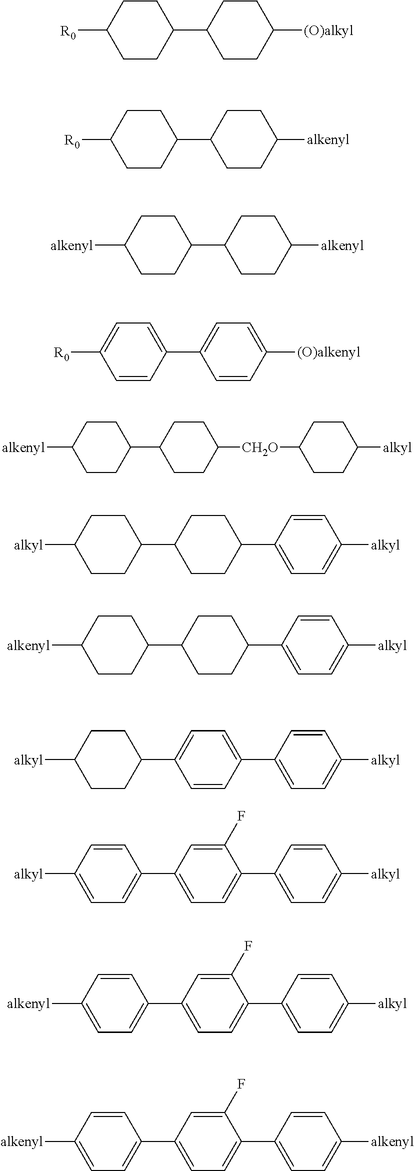
wherein R⁰ represents a 2-12 carbon n-alkyl group, n-alkoxy group, oxaalkyl group, fluoroalkyl group, alkenyloxy group, or alkenyl group; the alkyl group is a branched or unbranched alkyl group with 1-8 carbons, the (O)alkyl group represents a branched or unbranched alkenyl group or oxaalkyl group with 1-8 carbons, and the alkenyl group represents a branched or unbranched alkenyl group with 2-8 carbons.

11. The display panel as claimed in claim 1, wherein the diamine compound comprises at least one of following compounds:

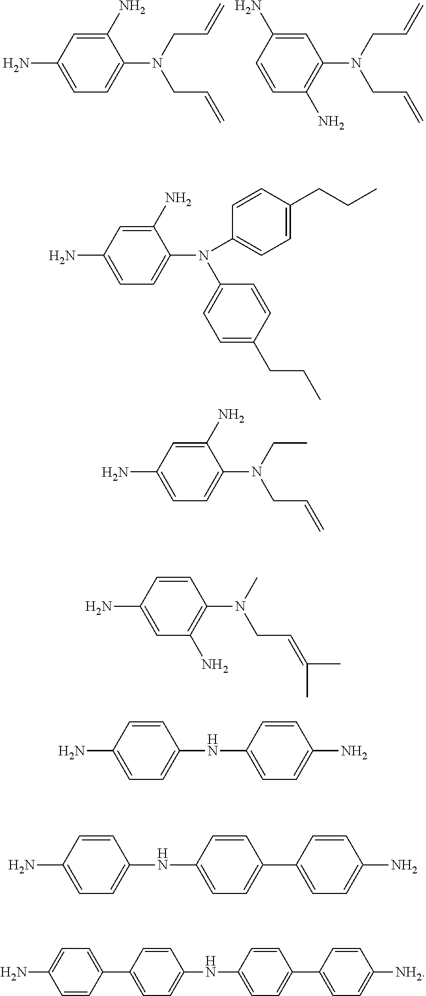

12. The display panel as claimed in claim 1, wherein the polar liquid crystal compound comprises at least one of following compounds: 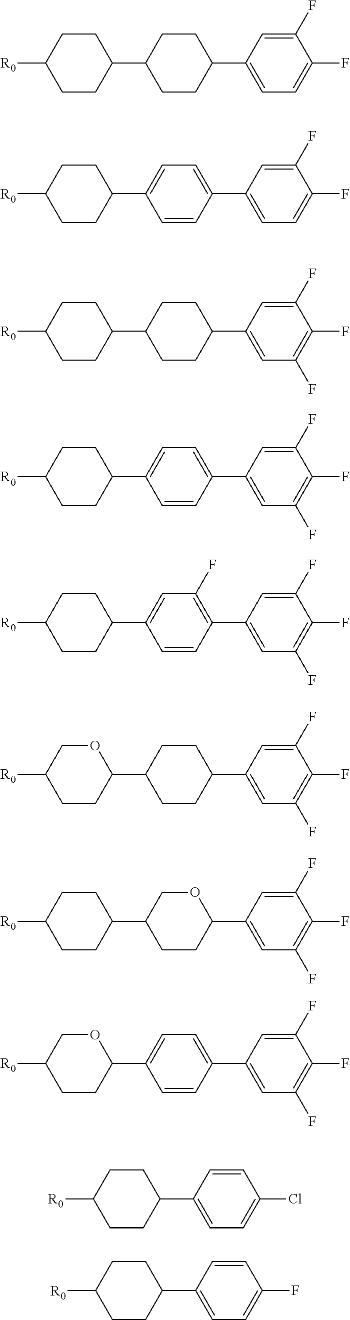 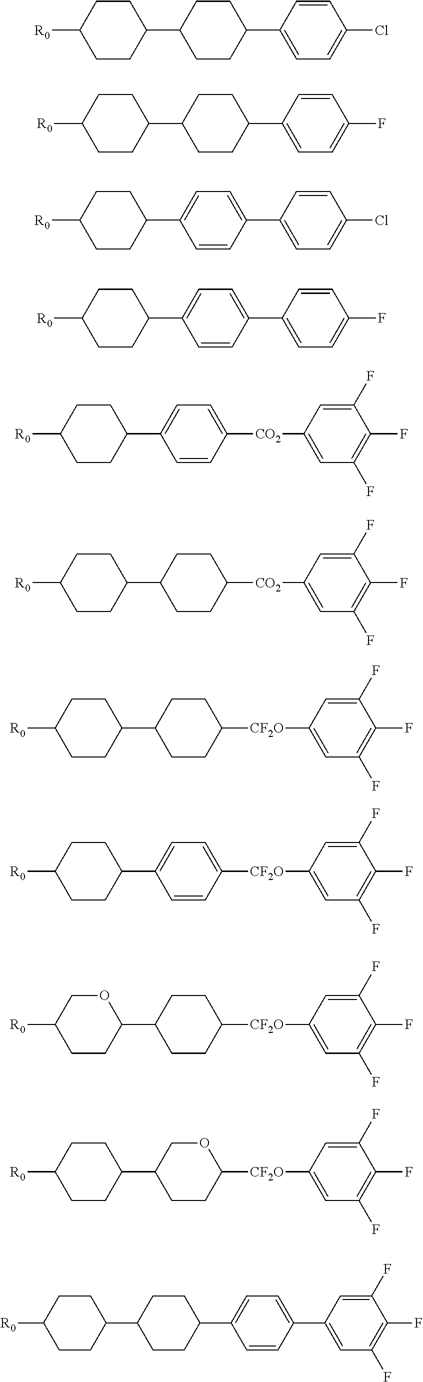 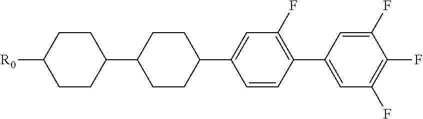
wherein R⁰ represents a 2-12 carbon n-alkyl group, n-alkoxy, oxaalkyl group, fluoroalkyl group, alkenyloxy group, or alkenyl group.

13. The display panel as claimed in claim 1, wherein the liquid crystal material mainly comprises: 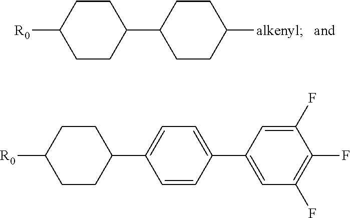
wherein R⁰ represents a 2-12 carbon n-alkyl group, n-alkoxy group, oxaalkyl group, fluoroalkyl group, alkenyloxy group, or alkenyl group.

14. (canceled)

15. The display panel as claimed in claim 1, wherein each of the first polar liquid crystal compound and the second polar liquid crystal compound comprises at least one of following compounds: 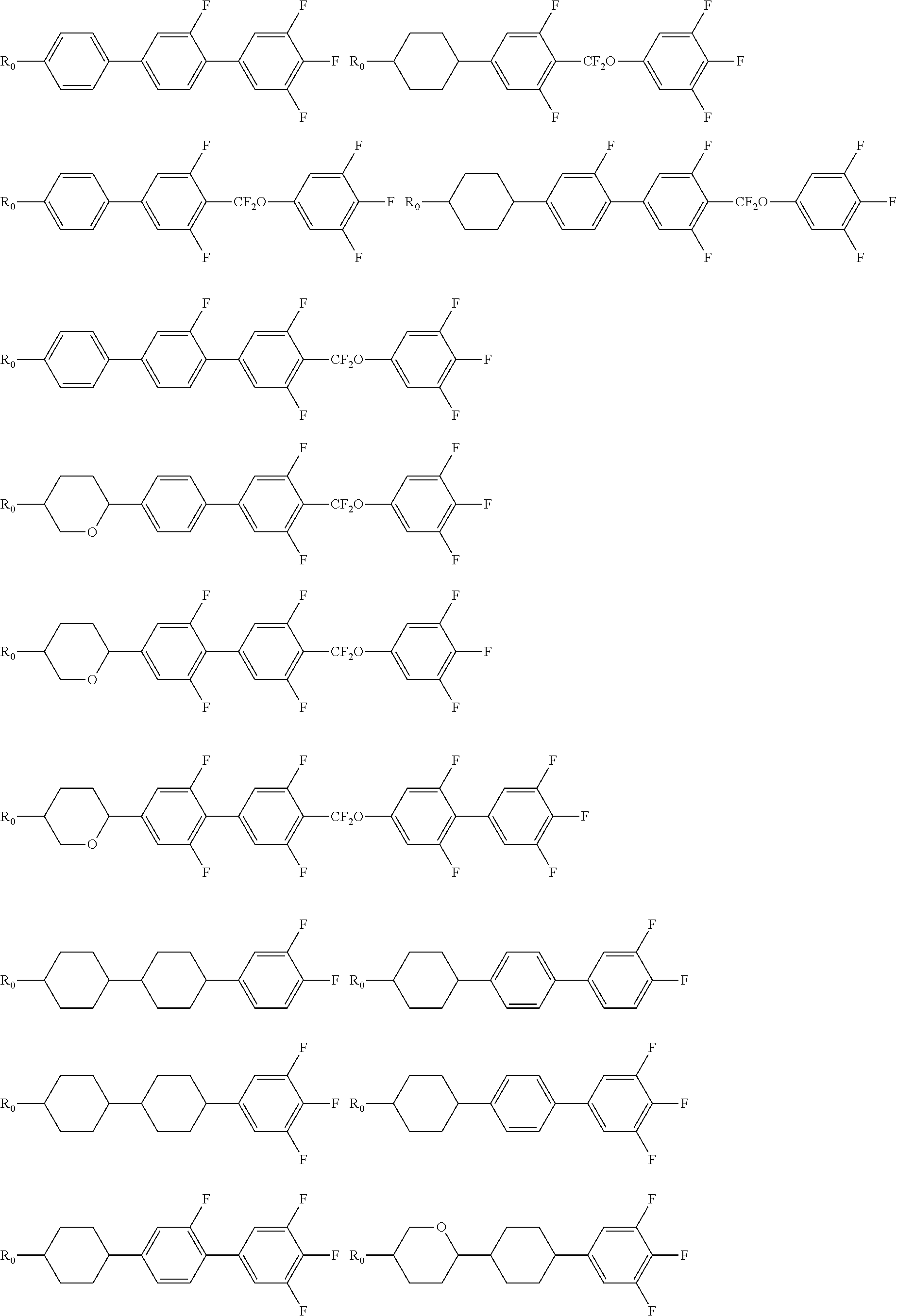 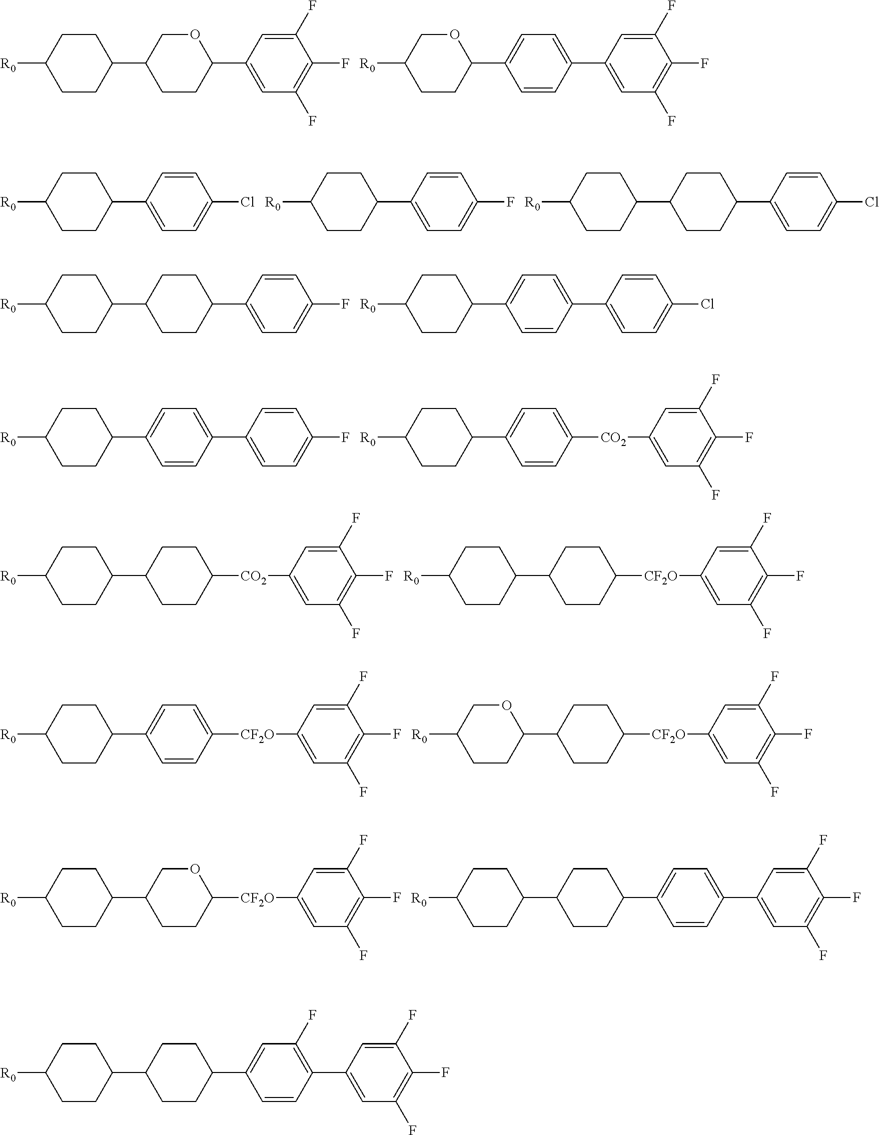
wherein R⁰ represents a 2-12 carbon n-alkyl group, n-alkoxy, oxaalkyl group, fluoroalkyl group, alkenyloxy group, or alkenyl group.

16. The display panel as claimed in claim 1, wherein the liquid crystal material mainly comprises: 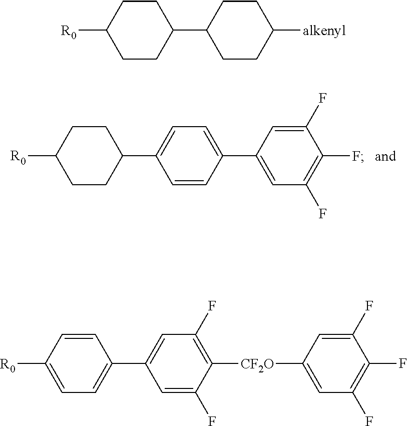
wherein R° represents a 2-12 carbon n-alkyl group, n-alkoxy group, oxaalkyl group, fluoroalkyl group, alkenyloxy group, or alkenyl group.

17. The display panel as claimed in claim 1, wherein the liquid crystal material comprises 15-35 wt % of the non-polar crystal compound and 65-85 wt % of the polar liquid crystal compound.

18. The display panel as claimed in claim 1, wherein the amount of the second polar liquid crystal compound is 0 wt %.
